(19) United States
(12) Patent Application Publication
(10) Pub. No.: US 2014/0292666 A1
(43) Pub. Date: Oct. 2, 2014

(54) Method and Apparatuses of User Interaction Control with Touch Display Device Integrated with Fingerprint Imager

(71) Applicants: Weidong Shi, Pearland, TX (US); Yang Lu, Pearland, TX (US)

(72) Inventors: Weidong Shi, Pearland, TX (US); Yang Lu, Pearland, TX (US)

(73) Assignee: Mobile Identity Management and Biometrics consortium, Pearland, TX (US)

(21) Appl. No.: 13/851,086

(22) Filed: Mar. 26, 2013

(51) Int. Cl. G06F 3/041; G06K 9/00

(52) U.S. Cl. CPC G06F 3/041; G06K 9/00087
USPC 345/173

(57) ABSTRACT

The present invention describes methods and apparatuses for supporting identity based user experiences by a computing apparatus wherein said computing apparatus comprises a biometric touch display wherein said biometric touch display further comprises one or a plurality of fingerprint imagers, an electronic touch display, and a control processing element wherein said control processing element is programmed to show user interface on the touch display, verify user identity, and respond to the touch accordingly.

### FIELD OF THE INVENTION

This invention relates to supporting identity based user experiences by a computing apparatus wherein said computing apparatus comprises a biometric touch display. The present application is a continuation-in-part of U.S. application Ser. No. 13/459,207, entitled “Methods and Apparatus of Integrating Fingerprint Imagers with Touch Panels and Displays”, filed Apr. 29, 2012; The present application is also a continuation-in-part of U.S. application Ser. No. 13/667,235, entitled “Methods and Apparatus for Managing Service Access Using a Touch-Display Device Integrated with Fingerprint Imager”, filed Nov. 2, 2012. The present application is also a continuation-in-part of U.S. application Ser. No. 13/757,993, entitled “Methods and Apparatuses of Transparent Fingerprint Imager Integrated with Touch Display Device”, filed Feb. 4, 2013. All of which are hereby incorporated by reference in their entireties.

### BACKGROUND OF THE INVENTION

### Brief Description of the Drawings

The invention may be better understood, and further advantages and uses thereof more readily apparent, when considered in view of the following detailed description of exemplary embodiments and examples, taken with the accompanying diagrams, in which:

FIG. 1 is a block diagram showing, in one exemplary embodiment of the present invention, the components involved for implementing identity based user interactions;

FIG. 2 is a block diagram showing, in one exemplary embodiment of the present invention, placement of user interface artifacts for supporting both touch interaction and identity verification;

FIG. 3 is a flowchart showing, in one exemplary embodiment of the present invention, the process of responding to user touch interaction;

FIG. 4 is a block diagram showing, in one exemplary embodiment of the present invention, the components involved for choosing user interface profile based on identity; and

FIG. 5 is a flowchart showing, in one exemplary embodiment of the present invention, the process of managing user interface profile based on user identity.

While the patent invention shall now be described with reference to the embodiments shown in the drawings, it should be understood that the intention is not to limit the invention only to the particular embodiments shown but rather to cover alterations, modifications and equivalent arrangements possible within the scope of appended claims. Throughout this discussion that follows, it should be understood that the terms are used in the functional sense and not exclusively with reference to a specific embodiment, or implementation, or programming interface.

### DETAILED DESCRIPTION OF THE PREFERRED EMBODIMENTS

Discussion in this section is intended to provide a brief description of some exemplary embodiments of the present invention.

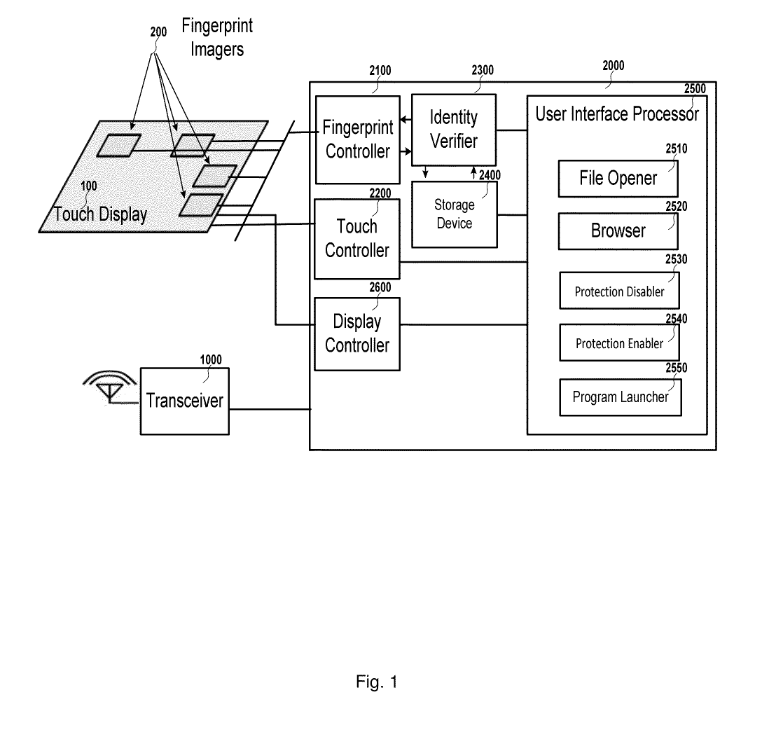

FIG. 1 is a block diagram showing, in one exemplary embodiment of the present invention, the components involved for implementing identity based user interactions.

In one exemplary embodiment, a computing apparatus (e.g., laptop, or desktop, or tablet, or notebook, or PDA, or mobile Internet device, or mobile phone, or handheld gaming device, or Kiosk) can comprise, an electronic touch display (100), one or a plurality of fingerprint imagers (200), a fingerprint controller (2100), a touch controller (2200), a display controller (2600), an identity verifier (2300), one or a plurality of storage devices (2400)), a user interface processor (2500), and one or a plurality of transceivers (1000).

An electronic display is an output device for presentation of information in visual form (e.g., OLED displays, liquid crystal display devices such as TFT-LCD, electronic paper display, Interferometric modulator display, Electrowetting display). In further exemplary embodiments, a display can be made using transparent components (e.g., transparent OLED).

A touch panel is a device that can detect the presence and location of a touch (e.g., capacitive touch panel, resistive touch panel, acoustic wave touch panel, infrared touch panel, projective capacitive touch panel, etc). A touch-panel controller is a component that can determine the location of the touch from a touch panel.

In one exemplary embodiment, a touch display (100) can comprise a touch panel and an electronic display. In an alternative embodiment, an embodiment of touch display (100) can integrate touch sensing circuitry and display together (e.g., in-cell touch-display panel).

A fingerprint imager (200) is an electronic device used to capture a digital image of the fingerprint pattern. The captured image can be digitally processed to create a biometric template (e.g., a collection of extracted features) which is stored and used for matching. Fingerprint imagers (200) include but not limited to optical fingerprint imagers, or ultrasonic fingerprint imagers, or thermal fingerprint imagers, or capacitive fingerprint imagers, or MEMS based fingerprint imagers, or fingerprint imagers built from nano materials (e.g., nano tubes, nano wires).

Depending on the implementations, a fingerprint imager (200) can cover part of or complete area of a touch display panel (100). A computing apparatus can comprise at least one such touch-display with integrated fingerprint imager (e.g., fingerprint imager overlayed on top of a touch panel, or fingerprint imager beneath a touch panel, or fingerprint imager in-between a touch panel and a display, or fingerprint imager combined with a touch panel or a display panel, or integrated together, or a hybrid device comprising fingerprint imagers and touch panel, or a hybrid device comprising fingerprint imagers and a touch-display panel) and use the fingerprint imager integrated touch-display panel for collecting fingerprint data.

The number of finerprint imagers depends on the implementation. Different embodiments can choose different number of fingerprint imagers. Placement of the fingerprint imagers also depens on the implementation. The present invention is not limited to any particular number of fingerprint imagers or limited to any specific placement or arrangement of fingerprint imagers. The described embodiments are for the purpose of illustration.

Furthermore, in an exemplary embodiment, a fingerprint imager (200) can be implemented as a TFT (thin-film transistors) based fingerprint imager. Each TFT fingerprint imager contains a matrix of fingerprint sensing cells, basic sensing unit of a fingerprint imager. The TFT fingerprint imagers can be visually transparent by using transparent electronic devices and fabrication processes.

The degree of fingerprint imager transparency is dependent of the embodiment.

In accordance with the present invention, transparent TFTs can be implemented using transparent semiconductors (e.g., transparent amorphous oxide materials, transparent organic thin-film transistors, transparent in-organic thin-film transistors, transparent nano-wire transistors, transparent nano-tube transistors, etc).

The fingerprint imagers (200) are controlled by a fingerprint controller (2100). A fingerprint controller (2100) can select and activate a fingerprint imager according to pre-determined conditions. In one exemplary embodiment, when a finger tip is inside the region covered by a fingerprint imager, its location can be recorded. Then the fingerprint controller can select and activate one or multiple fingerprint imagers to capture one or multiple fingerprints according to their locations.

An electronic storage device (2400) is any medium that can be used to record information electronically (e.g., volatile DRAM, non-volatile storage, solid state drive, hard disk, flash memory). In an exemplary embodiment, an electronic storage device can comprise non-volatile random access memory. A non-volatile random access memory retains its information when power is turned off (non-volatile). The memory can be integrated on-chip (e.g., non-volatile SRAMs, on-chip flash memory) or it can be off-chip (e.g., flash memory, ferroelectric RAM, magnetoresistive random-access memory, phase-change memory, nano-RAM, millipede memory, resistive random-access memory). In an exemplary embodiment, a computing apparatus can store fingerprint templates in a non-volatile storage device.

A transceiver (1000) (e.g, RF transceiver, ethernet transceiver) is a device comprising both transmitter and receiver handling circuitry. A RF Transceiver uses RF (radio frequency) modules for data transmission.

Depending on the implementations, an embodiment of a computing apparatus can comprise one or a plurality of transceivers (e.g., WiFi transceivers, cellular transceivers, ethernet transceivers).

A computing apparatus can comprise one or a plurality of control processing elements. A control processing element is an electronic circuit which executes computer programs. A control processing element can be implemented as system on a chip (SoC). A system on a chip or system on chip (SoC or SOC) is an integrated circuit (IC) that integrates components of a computer or other electronic system into a single chip. It may contain digital, or analog, or mixed-signal, or radio-frequency functions all on a single chip substrate. Sometimes, a SoC processor designed for supporting applications executed by a mobile computing system (e.g., tablet, mobile phone, mobile Internet device, handheld gaming device, PDA) is called application processor.

In an exemplary embodiment, a program executed by the control processing element is stored in one or a plurality of storage devices. Depending on the embodiments, when a program is stored, the program can be in the original form, or in encoded form, or in encrypted form, or in compressed form.

In one exemplary embodiment, an identity verifier (2300) can verify the identity of a user based on the fingerprint data captured by the fingerprint imager(s)(200). A user's identity is established when the fingerprint sample(s) is used to identify a user. A fingerprint is formed from the skin uneven surface of ridges and valleys.

In an exemplary embodiment, when a user touches the touch panel, a touch event will be generated and touch location (e.g., touch panel coordinate) will be recorded. When the controller gets the touch event and its touch panel coordinate, it can calculate the corresponding fingerprint imager coordinate according to fingerprint imagers location mapped to the touch panel space. If the calculated fingerprint imager coordinate is within the data capture range of one or multiple fingerprint imagers, the controller will enable these specific fingerprint imagers and capture the fingerprint by selecting these rows and columns surrounding the touch location.

In additional exemplary embodiments, for a captured fingerprint, before it is admitted, its quality can be evaluated. Low quality fingerprint data can be discarded. The admitted fingerprint will be used for identity verification by matching it with one or a plurality of fingerprint templates.

In accordance with the present invention, a computing apparatus can comprise a user identity repository (2420). The repository can store the fingerprint identity data for one or a plurality of users (e.g., owner or primary user of the computing apparatus, and/or children of the primary user of a computing apparatus, and/or spouse of the primary user of a computing apparatus, and/or colleagues of the primary user of a computing apparatus, and/or friends of the primary user of a computing apparatus, and/or administrator of a computing apparatus). Depending on the embodiments, a fingerprint identity comprises an image, or other captured sample, in its original, or processed (e.g., features or fingerprint template), or enhanced, or compressed form.

In further exemplary embodiment, the user identity repository (2420) is stored in one or a plurality of storage devices (2400).

In an exemplary embodiment of the present invention, a user interface processor (2500) can process a user touch input and respond accordingly. In further exemplary embodiments, a response of the user interface processor comprises showing a new interaction interface to the user. The interaction interface can be displayed by the touch display (100). In some embodiments, the interaction interface can be rendered by a display controller or a GPU (graphics processing unit).

In an exemplary embodiment, a user interface processor (2500) can be implemented as a program and executed by one or a plurality of control processing elements. The program can be stored in a storage device (2400) of the computing apparatus.

In an exemplary embodiment, a user interface can comprise one or a plurality of user interface artifacts (e.g., icon, or button, or menu, or widget). In additional exemplary embodiments of the present invention, a user interface artifact (e.g., icon, or button, or menu, or widget) can be displayed in area(s) of a touch display (100) where fingerprint(s) of a user can be captured by at least one fingerprint imager (200) when the user touches the user interface artifact.

In an exemplary embodiment of the present invention, a user interface artifact can comprise, a home button, or an icon of an application, or a search button, or a back button, or a start button (e.g., power on), or a restart button, or a power off button, or a setting button, or a browser button (e.g., container browser), or a file open button, or a button for enabling identity protection, or a button for disabling identity protection, etc.

In an exemplary embodiment, in response to a user's touch, identity verifier (2300) can check the identity of the user based on the sensed fingerprint data. If the user's identity is accepted, the user interface processor (2500) can respond to the user touch by taking certain actions.

In one exemplary embodiment and response scenario, when a user touches an interface artifact to open an electronic file (e.g., a document, or a movie file, or a word file, or a PDF file, or a presentation file, or a text file, or an email file, or a picture file, or a configuration file, or a password file, or a URL, or an audio file, etc), if the user's identity is accepted, a file opener (2510) can open the file and show its content on the touch display (100).

In another embodiment and response scenario, when a user touches a container (e.g., a folder, or a directory, or a gallery, etc) to browse its contents, if the user's identity is accepted, a browser (2520) can create a complete or partial view of the contents included in the container (e.g., files, or pictures, or movies, or documents) and show the view on the touch display (100).

In another embodiment and response scenario, when a user touches an application icon (e.g., smartphone app, or application software, or a program) to launch the application or switch to the application (if the application is already launched), if the user's identity is accepted, a program launcher (2550) can start the program by creating an execution context (e.g., process context, or thread context, or application context, or virtual machine context, etc). Furthermore, program execution refers to the process by which a computing apparatus carries out the instructions of the program.

In another embodiment and response scenario, when a user touches a button for enabling identity protection, if the user's identity is accepted, a protection enabler (2540) can put the computing apparatus in a state, called identity protection state, where identity protection is applied during touch interactions between a user and the computing apparatus. In an exemplary embodiment, when a computing apparatus is in identity protection state, the computing apparatus will verify identity of a user based on the fingerprint data sensed when the user interacts with the computing apparatus using touches.

In additional exemplary embodiments, when a computing apparatus is in the identity protection state, it can show a button on the touch display (100) for disabling identity protection.

In another embodiment and response scenario, when a user touches a button for disabling identity protection, if the user's identity is accepted (e.g., identity of the user matches with the user or one of the users who have the privilege to disable identity protection), a protection disabler (2530) can put the computing apparatus in a state, called no identity protection state, where the described identity protection is disabled.

In additional exemplary embodiments, when a computing apparatus is in the state with identity protection turned off, it can show a button on the touch display (100) for enabling identity protection.

Depending on the implementations, In one exemplary embodiment, when identity protection is disabled, a computing apparatus can power off the fingerprint imagers (200) and/or the fingerprint controller, or put the fingerprint imagers and/or the controller in idle or hibernation state.

In an alternative embodiment, when identity protection is disabled, a computing apparatus can turn off the identity verifier (2300), or bypass the identity verifier (2300), or ignore the output of identity verifier (2300).

In another embodiment and response scenario, when a user touches a power off button, if the user's identity is accepted (e.g., identity of the user matches with the user or one of the users who have the privilege to power off a computing apparatus), the computing apparatus can power off.

In another embodiment and response scenario, when a user touches a setting button, if the user's identity is accepted (e.g., identity of the user matches with the user or one of the users who have the privilege to change the settings of a computing apparatus), the computing apparatus will show a complete or partial view of the settings that the user can change on the touch display (100).

In another embodiment and response scenario, when a user touches a reset button, if the user's identity is accepted (e.g., identity of the user matches with the user or one of the users who have the privilege to reset a computing apparatus), the computing apparatus will power off and restart.

In another embodiment and response scenario, when a user touches a start button, if the user's identity is accepted (e.g., identity of the user matches with the user or one of the users who have the privilege to start a computing apparatus), the computing apparatus will start (e.g., switching from hibernation mode to power on mode, switching from a low power state to a functional state, switching from a minimal boot state to a booted state). In additional exemplary embodiments, after a computing apparatus is started, it will show a user interaction interface on the touch display (100).

In another embodiment and response scenario, when a user touches an unlock button, if the user's identity is accepted (e.g., identity of the user matches with the user or one of the users who have the privilege to unlock a computing apparatus, or matches with one of the users who have privilege to unlock a computing apparatus), the computing apparatus will unlock and respond to touch input from the user.

In accordance with the present invention, in an exemplary embodiment, when identity of a user cannot be verified by a computing apparatus, the computing apparatus can halt its response to the user's touch interaction. In an alternative embodiment, the computing apparatus can switch to a locked state and show a user interface that asks the user to unlock the computing apparatus.

It is worth to point out that the described embodiments are only for illustration purpose. Equivalent embodiments may be readily apparent to those of ordinary skill in the art. The present invention should not be limited only to the described embodiments herein.

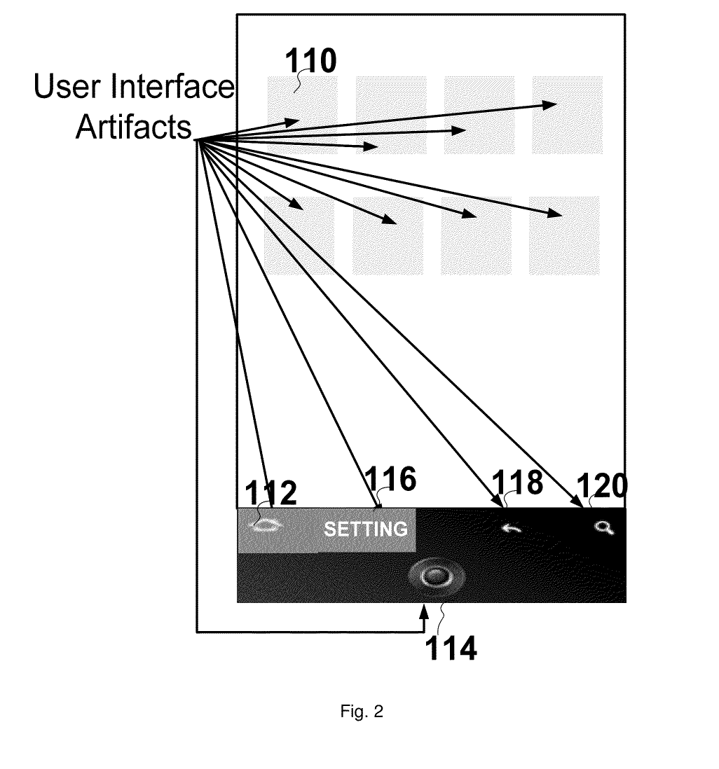

FIG. 2 is a block diagram showing, in one exemplary embodiment of the present invention, placement of user interface artifacts for supporting both touch interaction and identity verification.

In accordance with the present invention, In one exemplary embodiment, one or multiple human interface artifacts (e.g., button, menu, widget, icon, etc) can be shown on the display (100) and overlap with the area covered by one or multiple fingerprint imagers (200). A user interface artifact shown on a display is a graphical human interaction component that can respond to user actions (e.g., touch), including but not limited to, a button, or an icon, or a menu, or a widget, or a slider, or a draggable interaction component, or a droppable interaction component, or a data picker, or a dialog, or other similar human interaction component.

In an exemplary embodiment, a human interface artifact can be the commonly used GUI (Graphic User Interface) component (e.g., button, icon, menu). A human interface artifact can be a static or dynamic component. In an exemplary embodiment, when pressed or selected, certain functional response can be triggered. For example, in an exemplary embodiment, a human interface artifact can include, a home button (112), or a return/back button (118), or a cancel button, or a phone calling button, or a confirm button, or a menu button, or a search button (120), or an application launch icon (110), or a fire button, or a start button (e.g., power on), or a restart button, or a power off button, or a setting button (116), or a browser button (e.g., container browser), or a file open button, or a button for enabling identity protection, or a button for disabling identity protection, or a submit button, or a start button (114), etc.

In an exemplary embodiments of the present invention, a user interface artifact (e.g., icon, or button, or menu, or widget) can be displayed in area(s) of a touch display (100) where fingerprint(s) of a user can be captured by at least one fingerprint imager (200) when the user touches the user interface artifact.

For example, in an exemplary embodiment, when a user presses an application icon (110) and try to launch the application, the computing apparatus will sense the user's fingerprint(s) and verify the user's identity.

It is worth pointing out that the described embodiments are for the purpose of illustration. The present invention is not limited to any specific design of user interface or any specific arrangement of user interface artifacts. The user interface shown in FIG. 2 is only for illustration purpose.

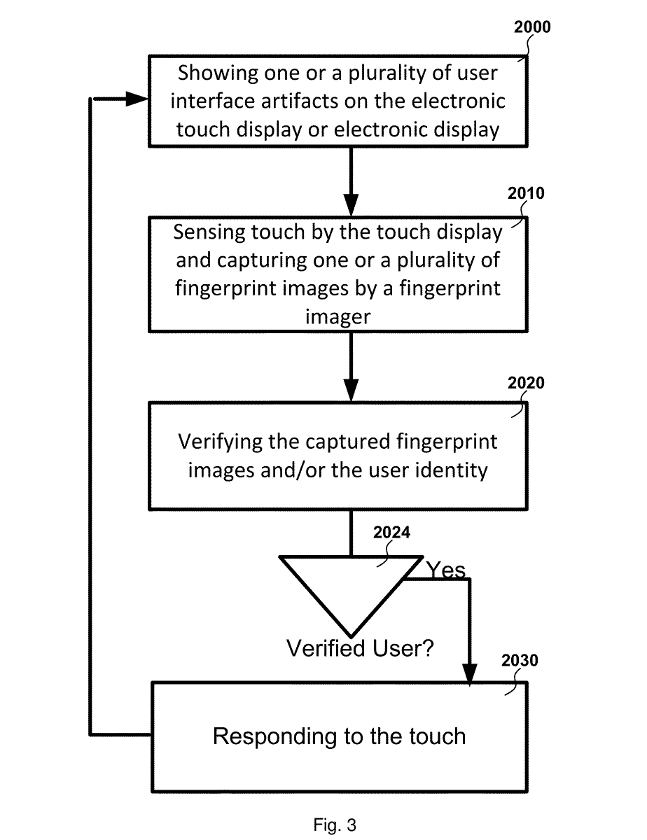

FIG. 3 is a flowchart showing, in one exemplary embodiment of the present invention, the process of responding to user touch interaction.

In one exemplary embodiment of the present invention, when a computing apparatus interacts with a user, it will show one or a plurality of user interface artifacts on the touch display (2000). The computing apparatus will sense touch made from a user and capture the user's fingerprint by one or a plurality of fingerprint imagers (2010). An identity verifier (2300) will verify the captured fingerprint image(s) (2020). In additional exemplary embodiments, the computing apparatus can comprise a repository of user identities (2420). Furthermore, the user identities can be stored in one or a plurality of storage devices. The computing apparatus will response to a user's touch interaction by taking certain actions (2030) (e.g., opening a file by a file opener, or open a folder by a browser, or disable identity protection by a protection disabler, or enable identity protection by a protection enabler, or launch a program by a program launcher).

In additional exemplary embodiments, the response depends on whether the user identity can be verified (2020).

In an exemplary embodiment of the present invention, a user interface artifact can comprise, a home button, or a return/back button, or a cancel button, or a phone calling button, or a confirm button, or a menu button, or a search button, or an application launch icon, or a fire button, or a start button (e.g., power on), or a restart button, or a power off button, or a setting button, or a browser button (e.g., container browser), or a file open button, or a button for enabling identity protection, or a button for disabling identity protection, or a submit button, etc.

In an exemplary embodiment, when a user touches the touch panel, a touch event will be generated and touch location (e.g., touch panel coordinate) will be recorded. When the controller gets the touch event and its touch panel coordinate, it can calculate the corresponding fingerprint imager coordinate according to fingerprint imagers location mapped to the touch panel space. If the calculated fingerprint imager coordinate is within the data capture range of one or multiple fingerprint imagers, the controller will enable these specific fingerprint imagers and capture the fingerprint by selecting these rows and columns surrounding the touch location.

In additional exemplary embodiments, for captured fingerprint, before it is admitted, its quality can be evaluated. Low quality finger-print data can be discarded. The admitted fingerprint will be used for identity verification by matching it with one or a plurality of fingerprint templates.

In accordance with the present invention, a computing apparatus can comprise a user identity repository (2420). The repository can store the fingerprint identity data for one or a plurality of users (e.g., owner or primary user of the computing apparatus, and/or children of the primary user of a computing apparatus, and/or spouse of the primary user of a computing apparatus, and/or colleagues of the primary user of a computing apparatus, and/or friends of the primary user of a computing apparatus, and/or administrator of a computing apparatus). Depending on the embodiments, a fingerprint identity comprises an image, or other captured sample, in its original, or processed (e.g., features or fingerprint template), or enhanced, or compressed form.

In one exemplary embodiment and response scenario, when a user touches an interface artifact to open an electronic file (e.g., a document, or a movie file, or a word file, or a PDF file, or a presentation file, or a text file, or an email file, or a picture file, or a configuration file, or a password file, or a URL, or an audio file etc), if the user's identity is accepted, a file opener (2510) can open the file and show its content on the touch display (100).

In another embodiment and response scenario, when a user touches a container (e.g., a folder, or a directory, or a gallery, etc) to browse its contents, if the user's identity is accepted, a browser (2520) can create a complete or partial view of the contents included in the container (e.g., files, or pictures, or movies, or documents) and show the view on the touch display (100).

In another embodiment and response scenario, when a user touches an application icon (e.g., smartphone app, application software, a program) to launch execution the application or switch to the application (if the application is already launched), if the user's identity is accepted, a program launcher (2550) can start the program by creating an execution context (e.g., process context, or thread context, or application context, or virtual machine context, etc).

In another embodiment and response scenario, when a user touches a button for enabling identity protection, if the user's identity is accepted, the computing apparatus can be put in the identity protection state where identity protection is applied during touch interactions between a user and the computing apparatus.

In another embodiment and response scenario, when a user touches a button for disabling identity protection, if the user's identity is accepted (e.g., identity of the user matches with the user or one of the users who have the privilege to disable identity protection), the computing apparatus can be put in the state where identity protection is disabled.

Depending on the implementations, In one exemplary embodiment, when identity protection is disabled, a computing apparatus can power off the fingerprint imagers (200) and/or the fingerprint controller, or put the fingerprint imagers and/or the controller in idle or hibernation state.

In an alternative embodiment, when identity protection is disabled, a computing apparatus can turn off the identity verifier (2300), or bypass the identity verifier (2300), or ignore the output of identity verifier (2300).

In another embodiment and response scenario, when a user touches a power off button, if the user's identity is accepted (e.g., identity of the user matches with the user or one of the users who have the privilege to power off a computing apparatus), the computing apparatus can power off.

In another embodiment and response scenario, when a user touches a setting button, if the user's identity is accepted (e.g., identity of the user matches with the user or one of the users who have the privilege to change the settings of a computing apparatus), the computing apparatus will show a complete or partial view of the settings that the user can change on the touch display (100).

In another embodiment and response scenario, when a user touches a reset button, if the user's identity is accepted (e.g., identity of the user matches with the user or one of the users who have the privilege to reset a computing apparatus), the computing apparatus will power off and restart.

In another embodiment and response scenario, when a user touches a start button, if the user's identity is accepted (e.g., identity of the user matches with the user or one of the users who have the privilege to start a computing apparatus), the computing apparatus will start (e.g., switching from hibernation mode to power on mode, or switching from a low power state to a functional state, or switching from a minimal boot state to a booted state). In additional exemplary embodiments, after a computing apparatus is started, it will show a user interaction interface on the touch display (100).

In another embodiment and response scenario, when a user touches an unlock button, if the user's identity is accepted (e.g., identity of the user matches with the user or one of the users who have the privilege to unlock a computing apparatus), the computing apparatus will unlock and respond to touch input from the user.

In accordance with the present invention, in an exemplary embodiment, when identity of a user cannot be verified by a computing apparatus, the computing apparatus can halt its response to the user's touch interaction. In an alternative embodiment, the computing apparatus can switch to a locked state and show a user interface that asks the user to unlock the computing apparatus.

It is worth to point out that the described embodiments are only for illustration purpose. Equivalent embodiments may be readily apparent to those of ordinary skill in the art. The present invention should not be limited only to the described embodiments herein.

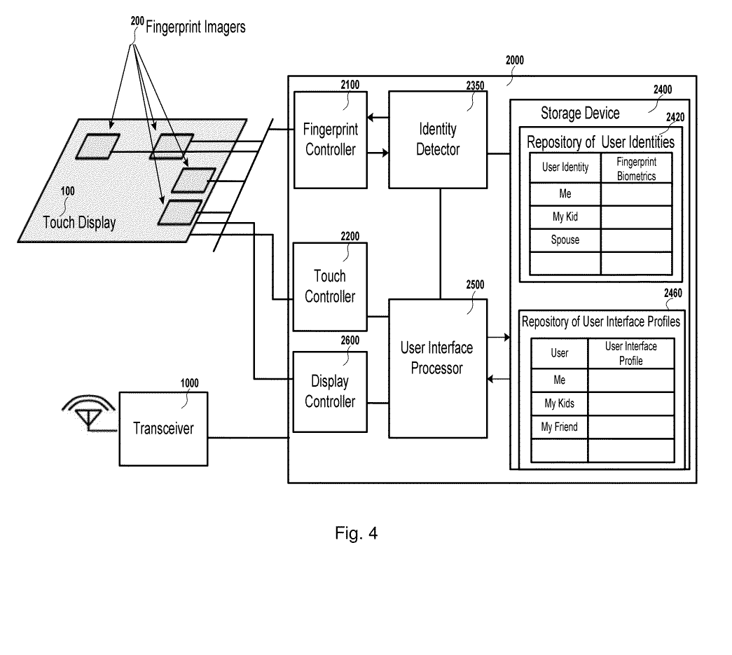

FIG. 4 is a block diagram showing, in one exemplary embodiment of the present invention, the components involved for choosing user interface profile based on identity.

In accordance with the present invention, in one exemplary embodiment, a computing apparatus (e.g., laptop, or desktop, or tablet, or notebook, or PDA, or mobile Internet device, or mobile phone, or handheld gaming device, or Kiosk) can comprise, an electronic touch display (100), one or a plurality of fingerprint imagers (200), a fingerprint controller (2100), a touch controller (2200), a display controller (2600), an identity detector (2350), one or a plurality of storage devices (2400), a user interface processor (2500), and one or a plurality of transceivers (1000).

In additional exemplary embodiments, a computing apparatus can comprise a user identity repository (2420). The user identity repository can be stored in one or a plurality of storage devices (2400). In further exemplary embodiments, a computing apparatus can comprise a repository of user interface profiles (2460).

Depending on the implementations, a repository of user interface profiles (2460) can be implemented as a database, or a configuration file, or a collection of configuration files, or a data structure (e.g., a table, or an array, or a hash table, or a list, or a graph, or a map, or key-value pairs, or priority queue, or other similar form). The user interface profile repository (2460) can be stored in one or a plurality of storage devices (2400).

In one exemplary embodiment of the present invention, a user interface profile specifies the kind of user experiences that one can have when interacting with a computing apparatus. For example, a computing apparatus can be shared between multiple users (e.g., the primary user, and/or children, and/or colleagues, and/or friends, and/or IT administrators). Different user interface profile can be defined for different types of users. Depending on the implementations, in an exemplary embodiment, a user interface profile can define user interface style, or access permissions to various functionalities of the computing apparatus (e.g., permission to change settings, or permission to install new applications, or permission to open certain file folders, or permission to use camera, or permission to open certain files, or permission to launch certain applications).

In an exemplary embodiment of the present invention, an identity detector (2350) can detect identity of a user who is interacting with a computing apparatus based on the fingerprint data captured by the fingerprint imager(s) (200). A user's identity is established when the fignerprint sample(s) is used to identify a user.

In an exemplary embodiment, when a user touches the touch panel, a touch event will be generated and touch location (e.g., touch panel coordinate) will be recorded. When the controller gets the touch event and its touch panel coordinate, it can calculate the corresponding fingerprint imager coordinate according to fingerprint imagers location mapped to the touch panel space. If the calculated fingerprint imager coordinate is within the data capture range of one or multiple fingerprint imagers, the controller will enable these specific fingerprint imagers and capture the fingerprint by selecting these rows and columns surrounding the touch location.

In additional exemplary embodiments, for captured fingerprint, before it is admitted, its quality can be evaluated. Low quality finger-print data can be discarded. The admitted fingerprint will be used for identity detection by matching it with one or a plurality of fingerprint templates.

In accordance with the present invention, a computing apparatus can comprise a user identity repository (2420). The repository can store the fingerprint identity data for one or a plurality of users (e.g., owner or primary user of the computing apparatus, or children of the primary user of a computing apparatus, or spouse of the primary user of a computing apparatus, or colleagues of the primary user of a computing apparatus, or friends of the primary user of a computing apparatus, or administrator of a computing apparatus). Depending on the embodiments, a fingerprint identity comprises an image, or other captured sample, in its original, or processed (e.g., features or fingerprint template), or enhanced, or compressed form.

In an exemplary embodiment of the present invention, based on the user's identity, a user interface profile can be selected and used as the current user interface profile. In additional exemplary embodiments, the user interface processor (2500) can display a user interface and respond to user's touches according to the current user interface profile. The interaction interface can be displayed by the touch display (100). In some embodiments, the interaction interface can be rendered by a display controller or a GPU (graphics processing unit).

In an exemplary embodiment, when the identity detector (2350) detects change of user, it can notify the user interface processor (2500). In one implementation, the user interface processor (2500) can be notified by an event posted by the identity detector (2350). Upon receipt of the event, the interface processor can switch user interface profile accordingly.

In another embodiment, the user interface processor (2500) can query the identity detector (2350) and find out the current user's identity. Based on the reply, the interface processor can continue to use the current user interface profile or switch to another user interface profile.

In another embodiment, the user interface processor (2500) and the identity detector (2350) can share a piece of data that records the current user identity and/or the current user interface profile. The data can be updated by the identity detector (2350) and accessed by the user interface processor (2500). The data can be stored in a storage device (e.g., volatile electronic storage, or non-volatile electronic storage).

In an exemplary embodiment, a user interface processor (2500) can be implemented as a program and executed by one or a plurality of control processing elements. The program can be stored in a storage device (2400) of the computing apparatus.

In response to a user touch, in some embodiments, a user interface processor can comprise, a file opener, or a browser, or protection disabler, or a protection enabler, or a program launcher. The kinds of response depend on the implementation. The present invention should not be limited to only the described responses.

It is worth to point out that the described embodiments are only for illustration purpose. Equivalent embodiments may be readily apparent to those of ordinary skill in the art. The present invention should not be limited only to the described embodiments herein. The user interface profiles and user identities shown in FIG. 4 are only for illustration purpose.

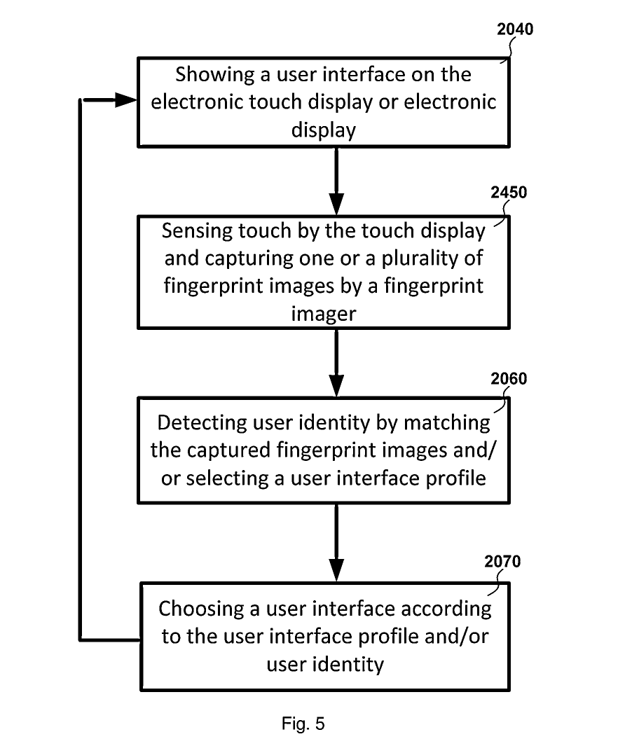

FIG. 5 is a flowchart showing, in one exemplary embodiment of the present invention, the process of managing user interface profile based on user identity.

In one exemplary embodiment of the present invention, when a computing apparatus interacts with a user, it will show a user interface on the touch display (2040). The computing apparatus will sense touch made from a user and capture the user's fingerprint by one or a plurality of fingerprint imagers (2050). An identity detector (2350) will detect identity of the user by matching the captured fingerprint image(s) with the fingerprint templates stored in the user identity repository (2060). Based on the user identity, the computing apparatus can either continue with the current user interface profile or switch to use another user interface profile (2070). The user interface processor (2500) is notified the current user identity and/or the current user interface profile.

In an exemplary embodiment, when a user touches the touch panel, a touch event will be generated and touch location (e.g., touch panel coordinate) will be recorded. When the controller gets the touch event and its touch panel coordinate, it can calculate the corresponding fingerprint imager coordinate according to fingerprint imagers location mapped to the touch panel space. If the calculated fingerprint imager coordinate is within the data capture range of one or multiple fingerprint imagers, the controller will enable these specific fingerprint imagers and capture the fingerprint by selecting these rows and columns surrounding the touch location.

In additional exemplary embodiments, for captured fingerprint, before it is admitted, its quality can be evaluated. Low quality finger-print data can be discarded. The admitted fingerprint will be used for identity verification by matching it with one or a plurality of fingerprint templates.

In one exemplary embodiment of the present invention, when identity of a user is detected, the computing apparatus can decide whether the current user interface profile should be changed. In one implementation, if the user is the same, the computing apparatus can continue using the current user interface profile. If the identity detector detects change of user identity, the computing apparatus can switch to a different user interface profile that matches with the detected user identity.

In one exemplary embodiment of the present invention, there can be a user interface profile for the primary user of a computing apparatus. In addition, there can be another user interface profile for colleagues. Depending on the implementations, there can be a user interface profile for the primary user's child (children). In further exemplary embodiments, there can be a user interface for the primary user's friends. When the identity detector (2350) detects identity change, the computing apparatus can switch user interface profile accordingly.

It should be understood that there exists implementations of other variations and modifications of the invention and its various aspects, as may be readily apparent to those of ordinary skill in the art, and that the invention is not limited by the specific embodiments described herein.

What is claimed is:

1. A method of responding to user touch interaction by a computing apparatus wherein said computing apparatus comprises a biometric touch display wherein said biometric touch display further comprises one or a plurality of fingerprint imagers, and an electronic touch display or electronic display, said method comprising,
showing one or a plurality of user interface artifacts on the electronic touch display or electronic display;
sensing touch by the touch display and capturing one or a plurality of fingerprint images by a fingerprint imager;
verifying the captured fingerprint images and/or the user identity; and
responding to the touch by the computing apparatus.

2. The method in claim 1 further comprising, showing the user interface artifacts on a transparent electronic display.

3. The method in claim 2 further comprising, capturing the fingerprint by an optical fingerprint imager wherein the optical fingerprint imager is situated behind an electronic display wherein the electronic display is a transparent display.

4. The method in claim 1 further comprising, capturing the fingerprint by a transparent capacitive TFT fingerprint imager.

5. The method in claim 1 wherein the computing apparatus responds to the touch, the method further comprising, opening a file by a file opener and displaying its content on the electronic display or electronic touch display.

6. The method in claim 1 wherein the computing apparatus responds to the touch, the method further comprising, opening a content folder by a browser and showing one or a plurality of user interface artifacts on the electronic display or electronic touch display.

7. The method in claim 1 wherein the computing apparatus responds to the touch, the method further comprising, launching a program by a program launcher wherein said program is stored in a storage device of the computing apparatus.

8. The method in claim 1 wherein the computing apparatus responds to the touch, the method further comprising, disabling identity protection by a protection disabler.

9. The method in claim 1 wherein the computing apparatus responds to the touch, the method further comprising, enabling identity protection by a protection enabler.

10. The method in claim 1 wherein the computing apparatus shows user interface artifacts, the method further comprising, showing one or a plurality of icons, and/or showing one or a plurality of buttons on the touch display.

11. A computing apparatus comprising,
a biometric touch display wherein said biometric touch display further comprises one or a plurality of fingerprint imagers, and an electronic touch display or an electronic display;
a control processing element wherein said control processing element is programmed to, show one or a plurality of user interface artifacts on the electronic touch display or electronic display; sense touch by the touch display and capture one or a plurality of fingerprint images by a fingerprint imager; verify the captured fingerprint images and/or the user identity; and respond to the touch by the computing apparatus.

12. The apparatus in claim 11 further comprising one or a plurality of transceivers.

13. The apparatus in claim 11 wherein the fingerprint imager is a transparent capacitive TFT fingerprint imager.

14. The apparatus in claim 11 wherein the fingerprint imager is an optical fingerprint imager.

15. The touch display in claim 11 comprising a transparent electronic display or a transparent electronic touch display.

16. The touch display in claim 11 comprising a touch panel or an in-cell touch display.

17. A method of responding to user touch interaction by a computing apparatus wherein said computing apparatus comprises at least one biometric touch display wherein said biometric touch display further comprises one or a plurality of fingerprint imagers, and an electronic touch display or an electronic display, said method comprising,
showing a user interface on the electronic touch display or electronic display;
sensing touch by the touch display and capturing one or a plurality of fingerprint images by a fingerprint imager;
detecting user identity by matching the captured fingerprint images and/or selecting a user interface profile; and
choosing a user interface according to the user interface profile and/or user identity;

18. A computing apparatus comprising,
a biometric touch display wherein said biometric touch display further comprises one or a plurality of fingerprint imagers, and an electronic touch display or an electronic display;
a control processing element wherein said control processing element is programmed to, show a user interface on the electronic touch display or electronic display; sense touch by the touch display and capture one or a plurality of fingerprint images by a fingerprint imager; detect user identity by matching the captured fingerprint images and/or select a user interface profile; and choose a user interface according to the user interface profile and/or user identity.

19. The apparatus in claim 18 further comprising one or a plurality of transceivers.

20. The apparatus in claim 18 wherein the fingerprint imager is a transparent 120 capacitive TFT fingerprint imager.
